(19) United States
(12) Patent Application Publication
(10) Pub. No.: US 2017/0082445 A1
(43) Pub. Date: Mar. 23, 2017

(54) MOBILE ELECTRONIC DEVICE, CONTROL METHOD, AND NON-TRANSITORY STORAGE MEDIUM

(71) Applicant: KYOCERA Corporation, Kyoto-shi, Kyoto (JP)

(72) Inventors: Shigeki TANABE, Yokohama-shi, Kanagawa (JP); Hideki MORITA, Yokohama-shi, Kanagawa (JP); Isao MASUIKE, Machida-shi, Tokyo (JP)

(21) Appl. No.: 15/312,366

(22) PCT Filed: May 21, 2015
(86) PCT No.: PCT/JP2015/064614

§ 371 Date: Nov. 18, 2016

(30) Foreign Application Priority Data
May 28, 2014 (JP) 2014-110112

(51) Int. Cl. G01C 21/20; H04W 4/02; G09B 29/10; H04W 4/04

(52) U.S. Cl. CPC G01C 21/206; H04W 4/043; H04W 4/046; H04W 4/028; G09B 29/106; H04W 88/08

(57) ABSTRACT

A mobile electronic device according to one aspect includes a display configured to display a map, and at least one controller configured to control display within an area indicating a facility in the map according to a distance between the mobile electronic device and the facility. The controller may control the display within the area indicating the facility according to a detected moving means and the distance. More specifically, the mobile electronic device displays, when the distance between the facility and the mobile electronic device is shorter than a predetermined distance, information for elements included in the facility within the area indicating the facility. On the other hand, when the distance between the facility and the mobile electronic device is not shorter than the predetermined distance, the mobile electronic device does not display the information for the elements included in the facility within the area indicating the facility.

### CROSS-REFERENCE TO RELATED APPLICATION

This application is a national stage of PCT International Application No. PCT/JP2015/064614 filed in Japan on May 21, 2015, which claims priority to and incorporates by reference the entire contents of Japanese Patent Application No. 2014-110112 filed in Japan on May 28, 2014.

### FIELD

The present disclosure relates to a mobile electronic device, a control method, and a non-transitory storage medium.

### BACKGROUND

Japanese Laid-open Patent 15 Publication No. 2002-296064 describes a route guide map display device capable of displaying an outdoor map and an indoor map as a route guide map and sequentially switching the displayed route guide map to the other at an arbitrary timing. The route guide map display device is capable of displaying the indoor map in addition to the outdoor map, as an information map, according to a user's switching operation.

### SUMMARY

A mobile electronic device, a control method, and a non-transitory storage medium are disclosed.

In one aspect, there is provided a mobile electronic device comprising a display configured to display a map, and at least one controller configured to control display within an area indicating a facility in the map according to a distance between the mobile electronic device and the facility.

In one aspect, there is provided a control method for controlling a mobile electronic device, comprising displaying a map on a display, and controlling display within an area indicating a facility in the map according to a distance between the mobile electronic device and the facility.

In one aspect, there is provided a non-transitory storage medium configured to store a control program for causing a mobile electronic device to execute displaying a map on a display, and controlling display within an area indicating a facility in the map according to a distance between the mobile electronic device and the facility.

### BRIEF DESCRIPTION OF THE DRAWINGS

FIG. 1 is a block diagram of a mobile electronic device according to an example of some embodiments.

FIG. 2 is a diagram illustrating an example of control performed by a map display function.

FIG. 3 is a diagram illustrating another example of the control performed by the map display function.

FIG. 4 is a flowchart illustrating an example of operations for the map display function of the mobile electronic device.

FIG. 5 is a flowchart illustrating an example of operations of a controller in map data acquisition processing.

FIG. 6 is a flowchart illustrating an example of operations of the controller in floor identification processing.

FIG. 7 is a block diagram of a mobile electronic device according to another example of the embodiments.

FIG. 8 is a diagram illustrating an example of the control performed by the map display function.

FIG. 9 is a diagram illustrating another example of the control performed by the map display function.

FIG. 10 is a flowchart illustrating another example of the operations of the controller in the floor identification processing.

FIG. 11 is a block diagram of a mobile electronic device according to still another example of the embodiments.

FIG. 12 is a flowchart illustrating still another example of the operations of the controller in the floor identification processing.

FIG. 13 is a block diagram of a mobile electronic device according to still another example of the embodiments.

FIG. 14 is a flowchart illustrating still another example of the operations of the controller in the floor identification processing.

FIG. 15 is a block diagram of a mobile electronic device according to still another example of the embodiments.

FIG. 16 is a flowchart illustrating still another example of the operations of the controller in the floor identification processing.

### DETAILED DESCRIPTION OF THE PREFERRED EMBODIMENTS

Exemplary embodiments for implementing the present disclosure will be explained in detail below with reference to the accompanying drawings. Examples of a mobile electronic devices explained in the following embodiments include, but are not limited to, a smartphone, a mobile phone, a tablet, a mobile personal computer, a digital camera, a media player, an electronic book reader, a navigator, and a gaming device.

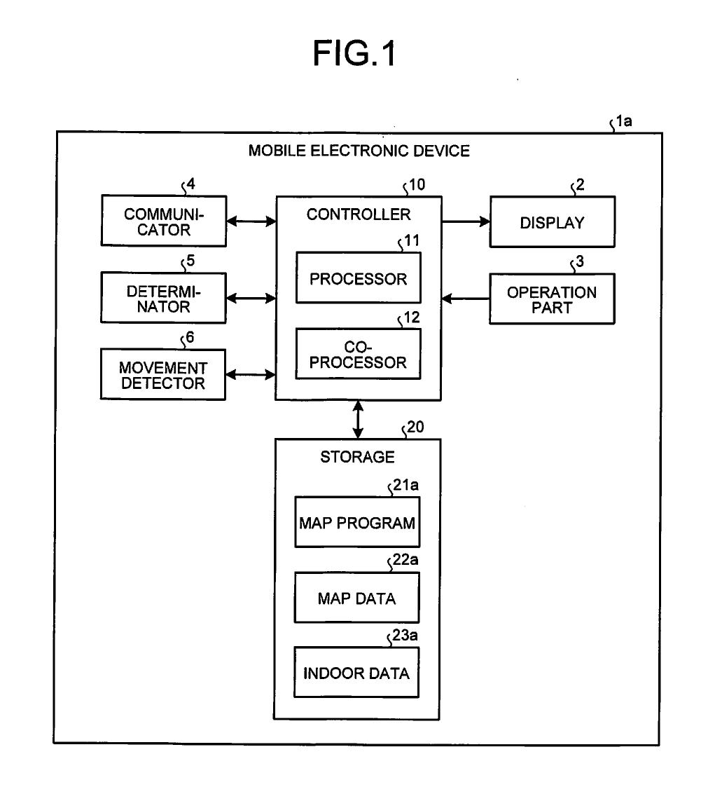

A configuration of a mobile electronic device 1a according to an example of the embodiments will be explained below with reference to FIG. 1. FIG. 1 is a block diagram of the mobile electronic device 1a. The mobile electronic device 1a includes a display 2, an operation part 3, a communicator 4, a determinator 5, a movement detector 6, a controller 10, and a storage 20.

The display 2 includes a display device such as a liquid crystal display, an organic electro-luminescence display, and an inorganic electro-luminescence display. The display 2 can display a screen including texts, images, symbols, graphics, and so on by the display device.

The operation part 3 can accept a user's operation. The operation part 3 includes, for example, a button, a keyboard, a dial, a lever, and a touch screen (touch sensor). The operation part 3 may accept an operation by a noncontact method such as sound and light. The operation part 3 may support a plurality of operation methods.

Whole or part of the operation part 3 may be integrated with the display 2. For example, a touch screen for detecting a contact is provided on a surface of the display 2, so that the mobile electronic device 1a may detect a gesture performed by the user using a finger or so on the display 2 via the touch screen.

The communicator 4 can perform wireless data communication with other communication device. The communicator 4 may support relatively wide-area wireless communications provided by a telecommunications provider. The relatively wide-area wireless communications provided by the telecommunications provider include, for example, so-called 3G and 4G. The communicator 4 may perform communication with other communication device via, for example, a wireless communication base station. The communicator 4 may support voice communication.

The determinator 5 determines a current location of the mobile electronic device 1a. The determinator 5 may determine the current location by a satellite positioning system such as GPS or GLONASS. The determinator 5 may determine the current location by other method instead of the satellite positioning system or in addition to this system. For example, the determinator 5 may determine the current location based on radio waves received by the communicator 4 and the wireless communication base station that transmits the radio waves. The determinator 5 may use secondarily various sensors provided in the mobile electronic device 1a such as an acceleration sensor, a gyroscope, and a direction sensor in order to determine the current location.

The movement detector 6 detects a movement of the mobile electronic device 1a in a three-dimensional space. The movement detected by the movement detector 6 includes, for example, a movement corresponding to a change in a location of the mobile electronic device 1a and a movement corresponding to a change in an attitude of the mobile electronic device 1a. The movement detector 6 may include various sensors such as an acceleration sensor, a gyroscope, and a direction sensor in order to detect the movement of the mobile electronic device 1a. The mobile electronic device 1a may acquire, by the movement detector 6, frequency and amplitude etc. of vibration of the mobile electronic device 1a caused by, for example, an external force.

The controller 10 controls the mobile electronic device 1a entirely. The controller 10 may include an arithmetic processing unit. The arithmetic processing unit includes a processor 11 and a coprocessor 12. Examples of the processor 11 and the coprocessor 12 include, but are not limited to, PU (Processing Unit), SoC (System-on-a-chip), MPU (Micro Processing Unit), and FPGA (Field-Programmable Gate Array).

The processor 11 implements various functions of the mobile electronic device 1a by executing various programs stored in the storage 20. Specifically, the processor 11 performs various controls by executing commands included in the programs while referring to data acquired from units of the mobile electronic device 1a and result of operation processing.

The coprocessor 12 operates with lower power consumption than the processor 11. Even when the processor 11 stops or decelerates the processing speed to reduce the power consumption, the coprocessor 12 is allowed to operate as usual. The coprocessor 12 having a property suitable for all-time operation can be used to, for example, acquire and analyze detection values of the various sensors, and perform processing according to the result of analysis.

The storage 20 stores programs and data. The storage 20 is used also as a working area that temporarily stores a processing result of the controller 10. The storage 20 may include non-transitory storage medium such as a semiconductor storage medium and a magnetic storage medium. The storage 20 may include a plurality of types of storage mediums. The storage 20 may include a combination of a portable storage medium such as a memory card, an optical disk, or a magneto-optical disk with a reading device of the storage medium. The storage 20 may include a storage device used as a temporary storage area such as RAM (Random Access Memory).

The storage 20 stores, for example, a map program 21a, map data 22a, and indoor data 23a. The map program 21a provides a function of displaying a map on the display 2. The map program 21a may also provide a function of guiding the user to a destination using the map. The map program 21a may be introduced via communication by the communicator 4 or via a non-transitory storage medium.

The map data 22a is basic data for displaying a map. The map data 22a may store pieces of graphic information corresponding to each element displayed in the map such as topography, roads, and facilities. The graphic information may be associated with character information displayed in the map such as a place name and a building name and with information indicating a location such as latitude and longitude. The map data 22a may further store various types of attribute information related to details of each element such as topography, roads, and facilities.

The indoor data 23a includes data for displaying information related to elements included inside a facility. The indoor data 23a may store, for example, graphic information corresponding to each element included in the facility, being associated with character information such as a name of an element and information indicating a location such as latitude and longitude. The indoor data 23a may further store various types of attribute information related to details of each element included in the facility.

For example, when the facility is a shopping mall where a plurality of stores are located, the indoor data 23a may store information related to the stores in the shopping mall. The information related to the store may include graphic information indicating a store and information such as a name of the store and a type of the store. For example, when the facility is an office building where a plurality of company offices are located, the indoor data 23a may store information related to offices included in the office building. The information related to the office may include graphic information indicating an office and information such as a name of a company. The indoor data 23a can include various pieces of information such as information related to stores in an underground mall, information related to platforms in an airport or a station, and information related to amusement attractions in an amusement park.

When the facility has a plurality of floors, information for the elements included in the facility may be stored in the indoor data 23a for each floor as information corresponding to the floor. The indoor data 23a does not have to include information for all the facilities included in the map data 22a.

The map data 22a and the indoor data 23a may be acquired from other communication device through communication by the communicator 4. The storage 20 may store, as the map data 22a and the indoor data 23a, a current location of the mobile electronic device 1a and information on its surroundings, a map displayed on the display 2 and information on its surroundings, or a frequently displayed map and information on its surroundings. In other words, the map data 22a and the indoor data 23a may include cached data.

In some embodiments, the map data 22a or the indoor data 23a includes information for entrances of a facility. The information for the entrances of the facility includes information for locations of entrances, information for floors where the entrances are located, and the like.

In the description according to the embodiments, for the sake of its simplicity, the map data 22a and the indoor data 23a are described as separate data; however, the map data 22a and the indoor data 23a may be integrated data.

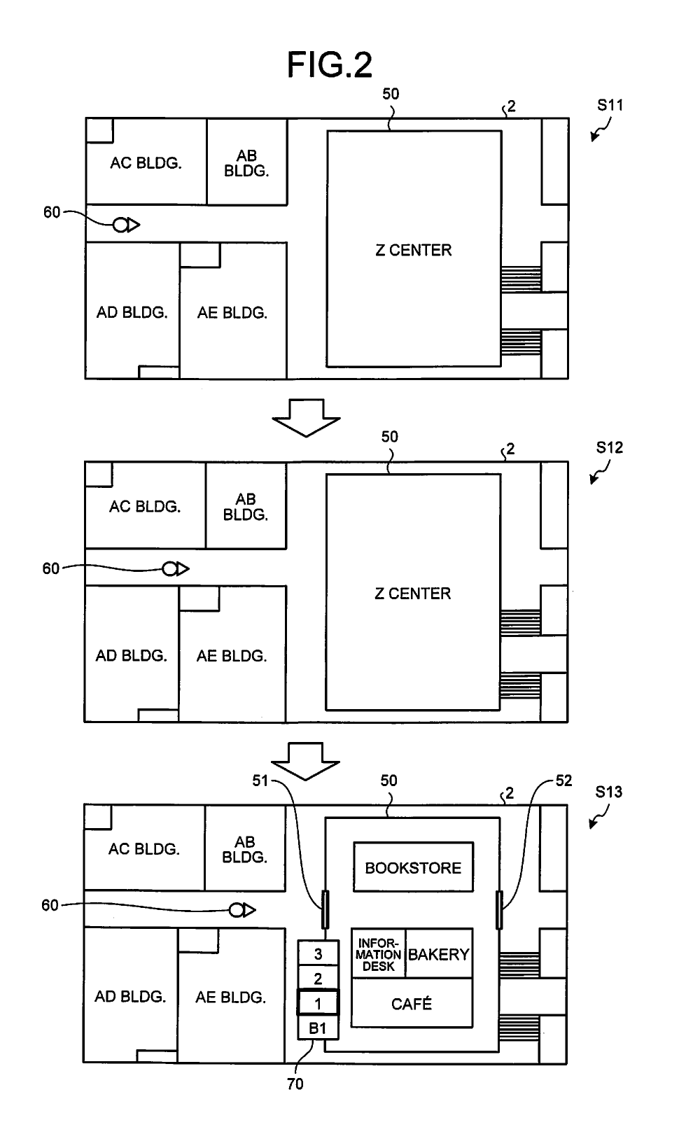

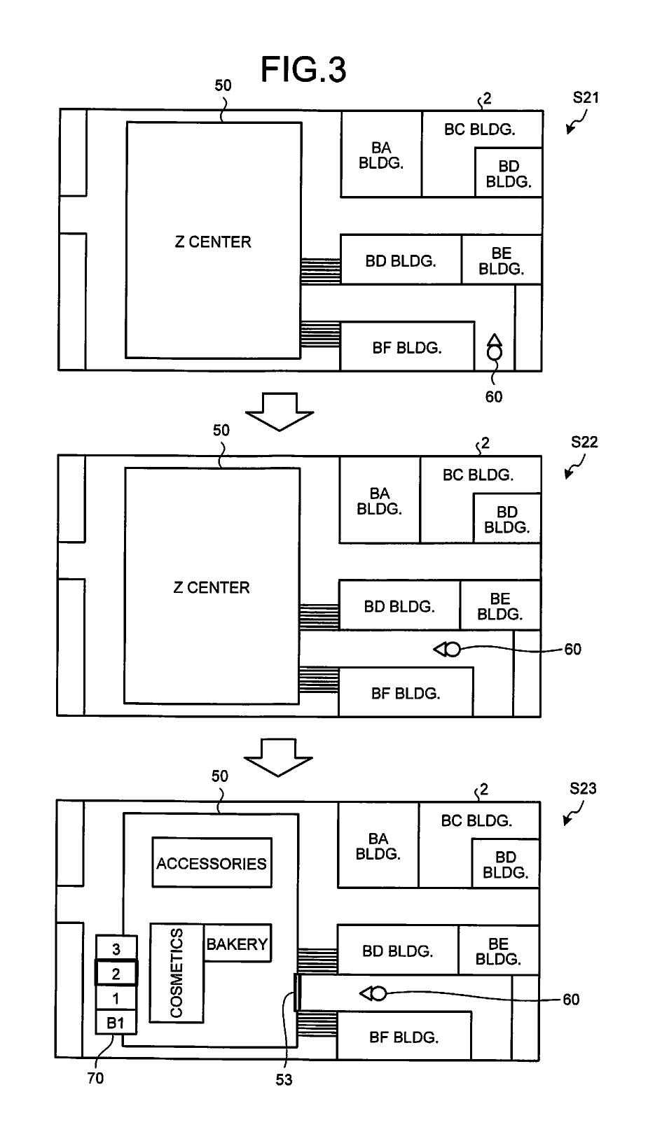

The mobile electronic device 1a implements a display function for displaying a map on the display 2 (hereinafter, it may be simply called “map display function”) by causing the controller 10 to execute the map program 21a. The map display function according to the embodiments will be explained in more detail below with reference to FIG. 2 and FIG. 3.

FIG. 2 is a diagram illustrating an example of control performed by the map display function. At Step S11 of FIG. 2, the display 2 displays a map using the map display function. The indoor data 23a includes information for a facility 50 of the facilities included in the map displayed at Step S11. The facility 50 is a shopping mall named as “Z center”, and includes a plurality of stores on each floor from a first basement floor to a third floor. The facility 50 has entrances 51 and 52 on the first floor and has an entrance 53 on the second floor.

An icon 60 indicating a current location of the mobile electronic device 1a is displayed in the map displayed at Step S11. In other words, the current location of the mobile electronic device 1a is the current location of the user of the mobile electronic device 1a.

At Step S11, the display 2 displays the icon 60 at a position farther as compared with a position with a predetermined distance apart from the facility 50. In other words, at Step S11, the distance between the mobile electronic device 1a and the facility 50 is relatively longer. In this case, the mobile electronic device 1a displays the information for the facility 50 on the display 2 without displaying elements such as stores included in the facility 50 using the indoor data 23a on the display 2. For example, as illustrated at Step S11, the mobile electronic device 1a displays a diagram indicating the location and range of the facility 50 and the name of the facility 50, as information for the facility 50, on the display 2.

In this way, the mobile electronic device 1a simplifies the map to be displayed by reducing the display of information on the elements included in the facility at a relatively farther location from the location of its own device. By simplifying the map, the user of the mobile electronic device 1a can more easily find out the destination. Especially, when the destination of the user is not the facility 50, the mobile electronic device 1a may reduce the information to be displayed on the display 2 by simplifying the map so as not to display the elements included in the facility 50 on the display 2. In other words, by reducing information except the destination to be displayed on the display 2, the user can more easily find out the destination. When the destination of the user is the facility 50 and if the facility 50 is located at a relatively farther location, it is assumed that user's biggest concern is where the facility 50 is and how to get there. When the destination is located at a relatively farther location from the location of the own device, the simplification of the map to be displayed makes the facility 50 itself stand out and satisfy the user's concern.

At Step S12, although the distance between the mobile electronic device 1a and the facility 50 becomes shorter than that illustrated at Step S11, the icon 60 is displayed still at a position farther as compared with the position with the predetermined distance apart from the facility 50. Therefore, similarly to Step S11, the mobile electronic device 1a displays information for the facility 50 with reduced display of the elements such as the stores included in the facility 50 by the indoor data 23a.

At Step S13, the mobile electronic device 1a is closer to the facility 50. In other words, the distance between the mobile electronic device 1a and the facility 50 becomes shorter than the predetermined distance. The predetermined distance is a distance at which the user can reach the facility shortly, for example, about several meters to 10 meters. The predetermined distance may be arbitrarily set by the user. When the distance between the mobile electronic device 1a and the facility 50 becomes shorter than the predetermined distance, the mobile electronic device 1a displays the elements such as the stores included in the facility 50 using the indoor data 23a. For example, as illustrated at Step S13, the mobile electronic device 1a displays the diagram indicating locations and ranges of the stores included in the facility 50 and names of the stores inside the facility 50.

At Step S13, the display 2 further displays a selector 70 indicating the floor where displayed stores etc. are located. The selector 70 is also used to switch the display of the floor. The selector 70 indicates that the floor where the displayed stores and the like are located is the first floor. At Step S13, the display 2 displays the entrances 51 and 52 located on the first floor.

In this way, when the distance between the mobile electronic device 1a and the facility 50 is shorter than the predetermined distance, the mobile electronic device 1a displays information related to the elements included in the facility 50. Therefore, the user can learn the information related to the inside of the facility 50 with a relatively small number of operations. As a result, the user can obtain benefits such that he/she can early know where a target store is located in the facility 50 or can early make sure that his/her destination is definitely the facility 50. When the user has already arrived somewhere near the facility 50 even if he/she is moving to a place other than the facility 50, the user is supposed to sufficiently understand paths near the facility 50. Thus, the user is less likely to become hard to know the path to the destination even if the information for the inside of the facility 50 is displayed.

When there is a plurality of floors in a facility located nearer than the predetermined distance, the mobile electronic device 1a displays information for elements located on a floor where an entrance, among the entrances of the facility, nearest to the mobile electronic device 1a is located. At Step S13, among the entrances of the facility 50, the nearest entrance to the mobile electronic device 1a is the entrance 51, which is located on the first floor of the facility 50. Therefore, at Step S13, the mobile electronic device 1a displays the information for the stores located on the first floor inside the facility 50. The information for the floor where the entrance 51 is located can be acquired from the map data 22a or the indoor data 23a.

FIG. 3 is a diagram illustrating another example of the control performed by the map display function. As illustrated in FIG. 3, the user is approaching the facility 50 from a direction and a height which are different from those of FIG. 2. At Step S21, because the distance between the mobile electronic device 1a and the facility 50 is longer than the predetermined distance, the mobile electronic device 1a reduces the display of the elements such as the stores included in the facility 50 by the indoor data 23a to display the information for the facility 50.

At Step S22, although the distance between the mobile electronic device 1a and the facility 50 becomes shorter than the distance at Step S21, the distance is still longer than the predetermined distance. Therefore, similarly to Step S21, the mobile electronic device 1a displays information for the facility 50 with reduced display of the elements such as the stores included in the facility 50 by the indoor data 23a.

At Step S23, the position of the mobile electronic device 1a is closer to the facility 50 than the position at Step S22. The distance between the mobile electronic device 1a and the facility 50 becomes shorter than the predetermined distance. Therefore, the mobile electronic device 1a displays the elements such as the stores included in the facility 50 by the indoor data 23a. At Step S23, among the entrances of the facility 50, the nearest entrance to the mobile electronic device 1a is the entrance 53, which is located on the second floor of the facility 50. Therefore, at Step S23, the mobile electronic device 1a displays the information for the stores etc. located on the second floor inside the facility 50.

In this way, by identifying the floor based on the distance to the entrance of the facility, the mobile electronic device 1a can display the information for the floor where the user is located at the time of entering the facility with high probability with a small number of user operations. Thus, the mobile electronic device 1a further enhances the convenience for the user.

One example of the control when the user of the mobile electronic device 1a is moving on foot has been explained with reference to FIG. 2 and FIG. 3. The mobile electronic device 1a may determine a moving means of the user. The mobile electronic device 1a may change the display control of the map according to the determined moving means. The mobile electronic device 1a may determine the moving means of the user based on, for example, a fluctuation pattern of detection values of a sensor such as an acceleration sensor provided in a movement detector 6. To reduce the power consumption, the mobile electronic device 1a may determine the moving means of the user by using the coprocessor 12. The mobile electronic device 1a may determine, for example, at least one of walking, running, bicycle, car, train, and aircraft, as a moving means.

When the moving means of the user is a vehicle, the user cannot enter the inside of the facility from an entrance for a pedestrian while riding on the vehicle. Accordingly, the user gets off the vehicle at the parking area or the station, etc., and enters inside of the facility on foot. Therefore, when the moving means of the user is a vehicle, the mobile electronic device 1a does not display the information for the elements included in the facility within an area indicating the facility even if the distance between the facility and the mobile electronic device 1a is shorter than the predetermined distance. Examples of the vehicle include, but are not limited to, a bicycle, a car, a train, and an aircraft.

Meanwhile, when the moving means of the user is not the vehicle, if the distance between the facility and the mobile electronic device 1a is shorter than the predetermined distance and there is a facility whose information for internal elements is stored in the indoor data 23a, the mobile electronic device 1a displays the information for the elements included in the facility within the area indicating the facility. The case in which the moving means of the user is not the vehicle includes a case in which the user moves on foot while getting off the vehicle.

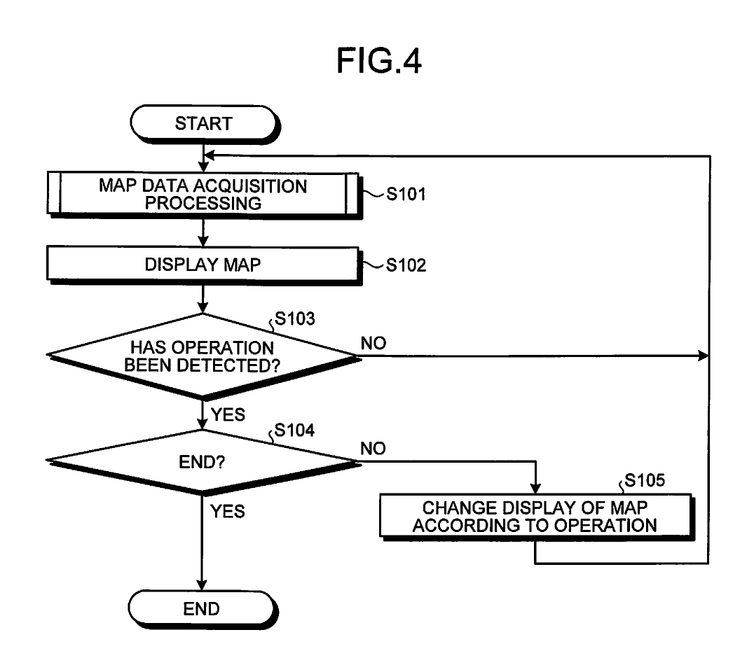

An example of the operations of the mobile electronic device 1a will be explained in more detail below with reference to FIG. 4 to FIG. 6. FIG. 4 is a flowchart illustrating an example of the operations for the map display function of the mobile electronic device 1a. The operations illustrated in FIG. 4 may be implemented by the controller 10 of the mobile electronic device 1a executing the map program 21a.

At Step S101, the controller 10 acquires data for displaying a map by performing the map data acquisition processing. Details of the map data acquisition processing will be explained later. At Step S102, the controller 10 uses the acquired data to display the map on the display 2.

Subsequently, at Step S103, the controller 10 detects whether a user operation has been detected. When a user operation has not been detected (No at Step S103), the controller 10 returns to Step S101. When a user operation has been detected (Yes at Step S103), the controller 10 proceeds to Step S104.

At Step S104, the controller 10 determines whether the detected operation is to end the map display function. When the detected operation is not to end the map display function (No at Step S104), the controller 10 proceeds to Step S105. At Step S105, the controller 10 changes the display of the map according to the detected operation. For example, the controller 10 enlarges, reduces, and scrolls the map. When the detected operation is to end the map display function (Yes at Step S104), the controller 10 ends the operation illustrated in FIG. 4.

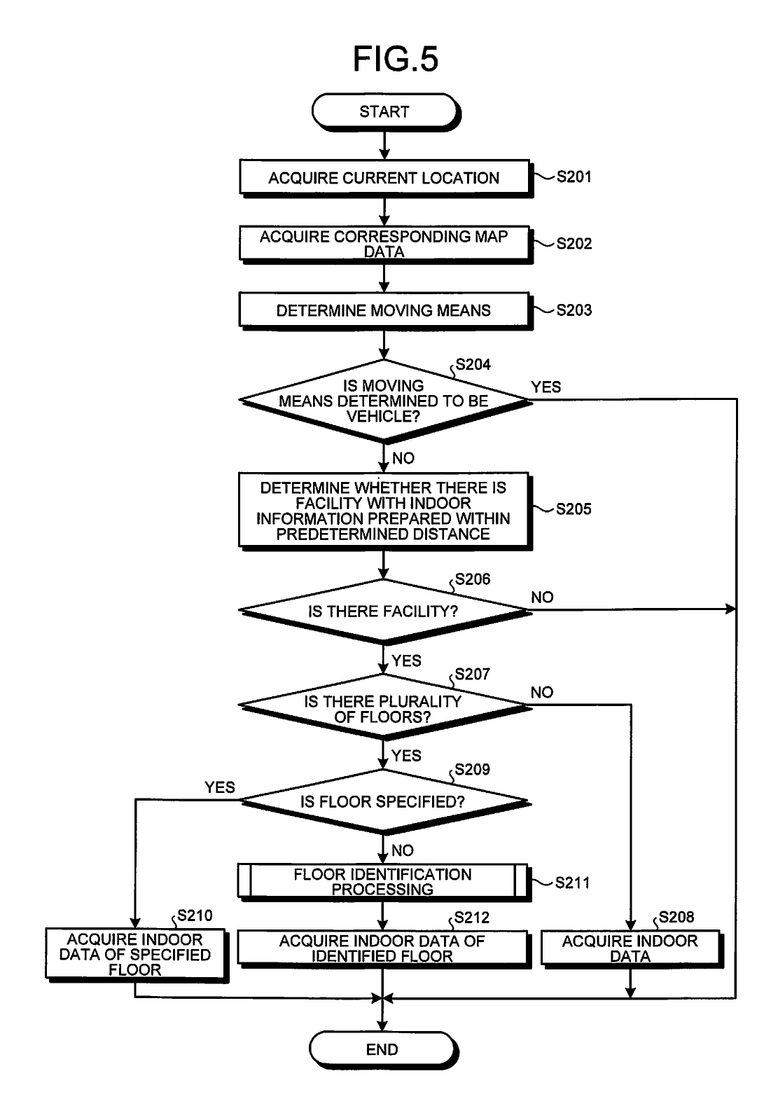

FIG. 5 is a flowchart illustrating an example of operations of the controller 10 in map data acquisition processing. At Step S201, the controller 10 uses the determinator 5 to acquire a current location. At Step S202, the controller 10 acquires data corresponding to the current location from the map data 22a. Subsequently, at Step S203, the controller 10 determines moving means of the user. When the moving means is a vehicle (Yes at Step S204), the controller 10 ends the map data acquisition processing.

When the moving means is not a vehicle (No at Step S204), the controller 10 proceeds to Step S205. At Step S205, the controller 10 determines whether there is a facility whose information for internal elements is stored in indoor data 23a within a predetermined distance. When there is no such facility (No at Step S206), the controller 10 ends the map data acquisition processing.

When there is a facility whose information for internal elements is stored in the indoor data 23a within the predetermined distance (Yes at Step S206), the controller 10 proceeds to Step S207. At Step S207, the controller 10 determines whether there is a plurality of floors in the facility. When there is one floor in the facility (No at Step S207), the controller 10 proceeds to Step S208. At Step S208, the controller 10 acquires the information for the internal elements of the facility from the indoor data 23a. The acquired information is used to display the information for the elements included in the facility within the area indicating the facility.

When there is a plurality of floors in the facility (Yes at Step S207), the controller 10 proceeds to Step S209. At Step S209, the controller 10 determines whether a floor is specified. The floor is specified by, for example, the user operating the operation part 3. When a floor is specified (Yes at Step S209), the controller 10 proceeds to Step S210. At Step S210, the controller 10 acquires the information for the elements located on the specified floor from the indoor data 23a. The acquired information is used to display the information for the elements included in the facility within the area indicating the facility.

When no floor is specified (No at Step S209), the controller 10 proceeds to Step S211. At Step S211, the controller 10 performs floor identification processing to identify the floor where the user is located at the time of entering the facility. Details of the floor identification processing will be explained later. At Step S212, the controller 10 acquires the information for the elements located on the identified floor from the indoor data 23a. The acquired information is used to display the information for the elements included in the facility within the area indicating the facility.

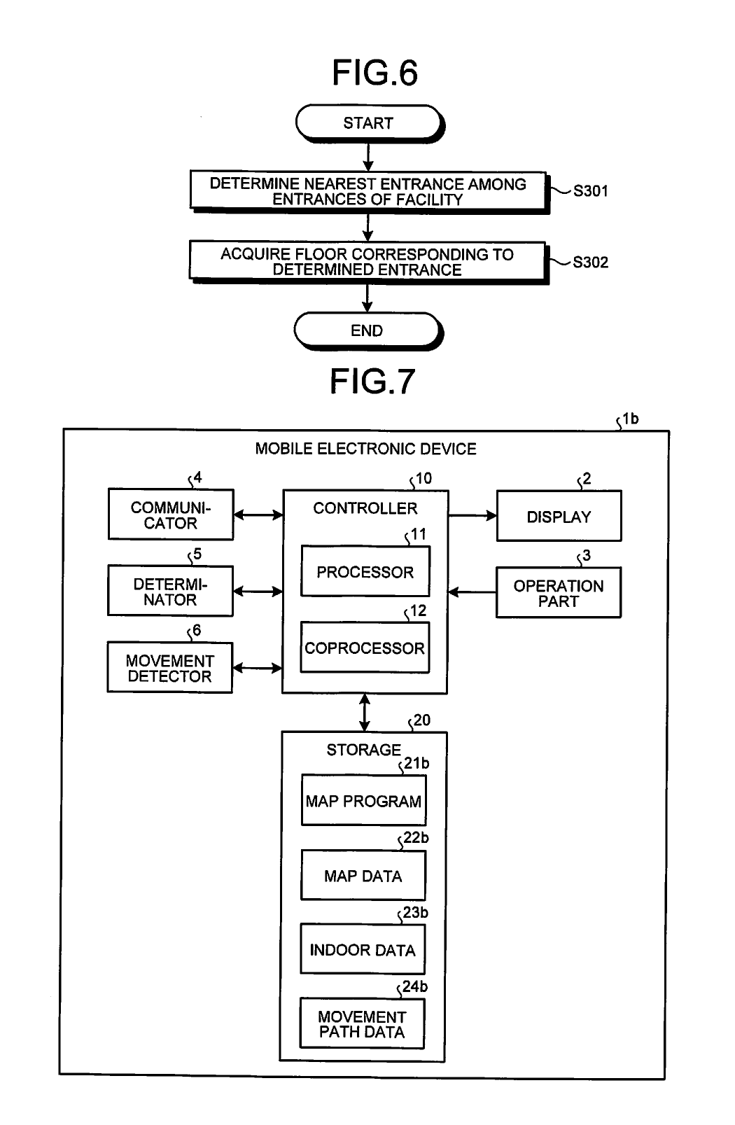

FIG. 6 is a flowchart illustrating an example of the operations of the controller 10 in the floor identification processing. At Step S301, the controller 10 determines which of entrances of the facility is the nearest to the current location. At Step S302, the controller 10 acquires a floor corresponding to the determined entrance. The floor acquired at Step S302 is the identified floor as the floor where the user is located at the time of entering the facility.

As explained above, the mobile electronic device 1a controls the display within the area of the facility according to the distance between the facility and the mobile electronic device 1a. More specifically, when the distance between the facility and the mobile electronic device 1a is shorter than the predetermined distance, the mobile electronic device 1a displays the information for the elements included in the facility within the area indicating the facility. Meanwhile, when the distance between the facility and the mobile electronic device 1a is not shorter than the predetermined distance, the mobile electronic device 1a does not display the information for the elements included in the facility within the area indicating the facility. With this control, the mobile electronic device 1a can change contents of the map according to a user's behavior. As a result, the mobile electronic device 1a can enhance convenience for the user.

Moreover, when there is a plurality of floors in a facility within the predetermined distance from the mobile electronic device 1a, the mobile electronic device 1a may identify the floor where the user is located at the time of entering the facility based on the current location. The mobile electronic device 1a may display the information for the elements located on the identified floor within the area indicating the facility. As a result, convenience of the mobile electronic device 1a is further improved.

Other examples of the embodiments will be explained. In the following explanation, the same reference signs as those of already explained portions are assigned to the same portions as already explained portions, and the overlapping explanation will not be repeated.

FIG. 7 is a block diagram of a mobile electronic device 1b according to another example of the embodiments. The mobile electronic device 1b includes the display 2, the operation part 3, the communicator 4, the determinator 5, the movement detector 6, the controller 10, and the storage 20.

The storage 20 stores, for example, a map program 21b, map data 22b, indoor data 23b, and movement path data 24b.

Movement paths of the mobile electronic device 1b are recorded in the movement path data 24b. More specifically, current locations of the mobile electronic device 1b are time-sequentially recorded in the movement path data 24b. For example, the current location is recorded in the movement path data 24b so as to learn a path along which the user moves on foot by several meters to several 10 meters. The mobile electronic device 1b may record the current location by the coprocessor 12 in order to reduce power consumption.

The map data 22b may store information for outdoor passages where people can pass. The information for the passage may include information for a range and a location of a band-like area indicating a passage, information for contacts with other passages, and the like. For example, when there are sidewalks on both sides of a road, information for a right-side passage of the road and information for a left-side passage of the road may be stored in the map data 22b. Moreover, information for each of floors included in the facility and information for passages connected to the floors may be stored in the map data 22b in association with each other. The information for each of the floors included in the facility and the information for passages connected to the floors may be stored in the indoor data 23b.

Except for the above points, the map data 22b and the indoor data 23b may be the same as the map data 22a and the indoor data 23a.

The map program 21b may be the same as the map program 21a except for a function of identifying the floor where the user is located at the time of entering the facility. According to the function provided by the map program 21b, the mobile electronic device 1b can identify the floor where the user is located at the time of entering the facility based on the movement path of the mobile electronic device 1b.

Specifically, the mobile electronic device 1b may identify a passage corresponding to the movement path recorded in the movement path data 24b. The mobile electronic device 1b may identify the floor associated with the identified passage as the floor where the user is located at the time of entering the facility. The passage corresponding to the movement path may be identified, for example, by comparing each of the current locations constituting the movement path with the band-like area of a neighboring passage. When there is a plurality of floors associated with the identified passage, the mobile electronic device 1b may identify a floor, in which a moving distance to the entrance of the facility is the shortest, as the floor where the user is located at the time of entering the facility. The moving distance to the entrance of the facility may be calculated by, for example, a technology of guiding the user to the destination.

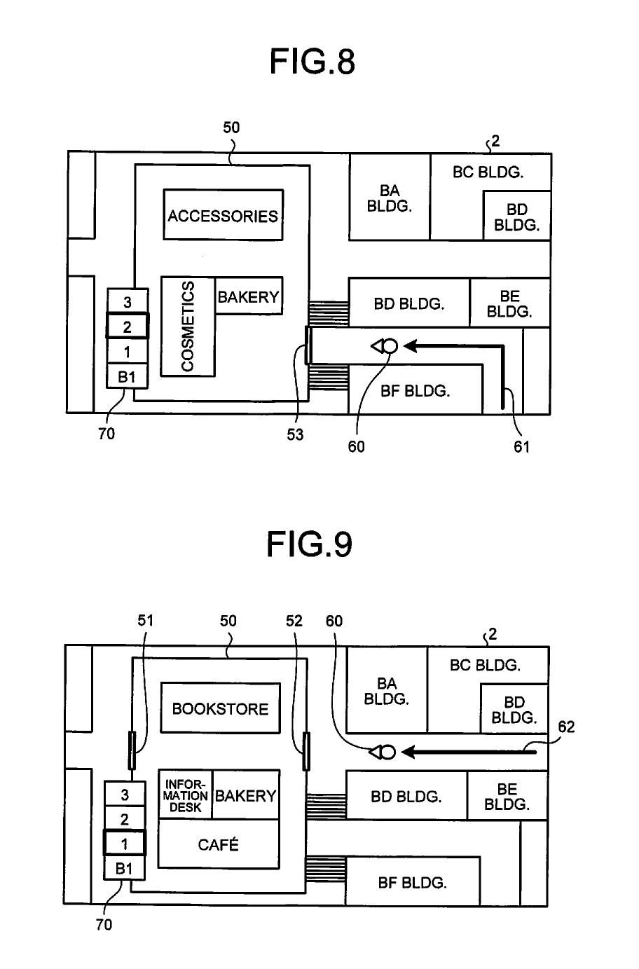

FIG. 8 and FIG. 9 are diagrams illustrating another examples of the control performed by the map display function. In the examples of FIG. 8 and FIG. 9, the user is approaching the facility 50 in an opposite direction in the example illustrated in FIG. 2.

In the example of FIG. 8, the distance between the mobile electronic device 1b and the facility 50 is shorter than the predetermined distance. Moreover, the movement path data 24b may store a movement path 61. In this case, the mobile electronic device 1b may identify a passage corresponding to the movement path 61 from the passages stored in the map data 22b. In this example, the identified passage is associated with the second floor of the facility 50. Therefore, the mobile electronic device 1b can display information for elements located on the second floor of the facility 50 inside the facility 50.

In the example of FIG. 9, the distance between the mobile electronic device 1b and the facility 50 is shorter than the predetermined distance. Moreover, the movement path data 24b may store a movement path 62. In this case, the mobile electronic device 1b may identify a passage corresponding to the movement path 62 from the passages stored in the map data 22b. In this example, the identified passage is associated with the first floor of the facility 50. Therefore, the mobile electronic device 1b can display information for elements located on the first floor of the facility 50 inside the facility 50.

The operations of the mobile electronic device 1b will be explained in more detail below. The operations of the mobile electronic device 1b may be the same as those of the mobile electronic device 1a except for the floor identification processing. Therefore, the floor identification processing will be explained below.

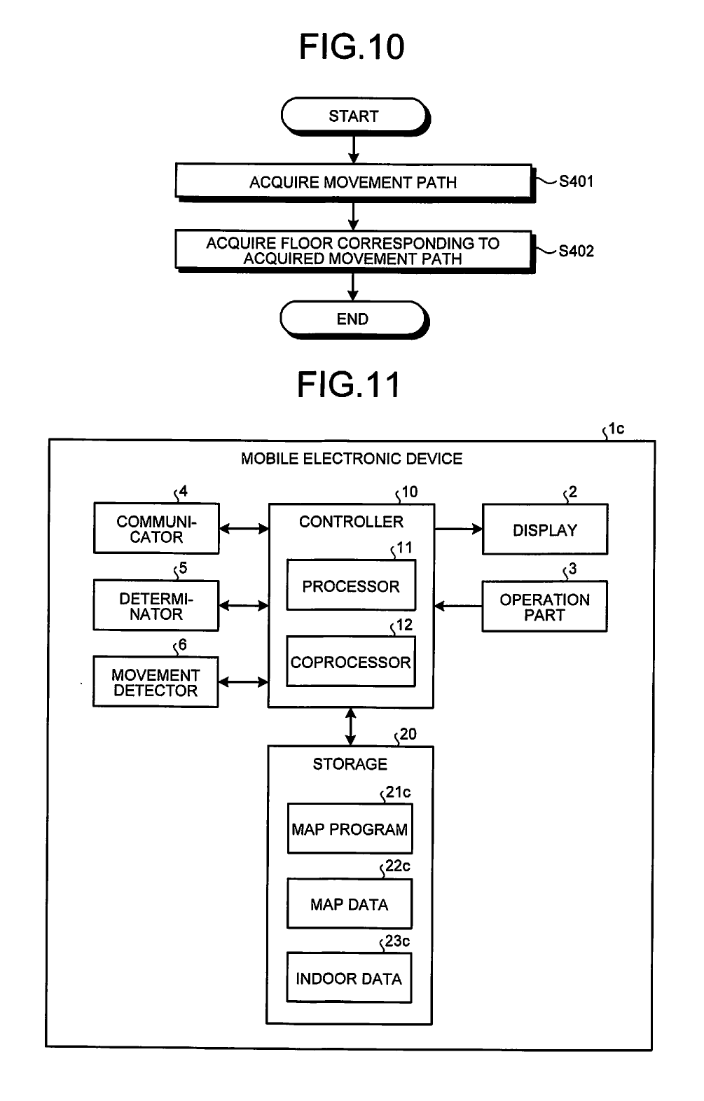

FIG. 10 is a flowchart illustrating another example of the operations of the controller 10 in the floor identification processing. At Step S401, the controller 10 acquires a movement path from the movement path data 24b. At Step S402, the controller 10 acquires a floor corresponding to the movement path. More specifically, the controller 10 identifies a passage along which the user is walking based on the movement path to acquire the floor associated with the passage. The floor acquired at Step S402 is the identified floor as a floor where the user is located at the time of entering the facility.

As explained above, the mobile electronic device 1b identifies the passage along which the user has been walking based on the movement paths and identifies the floor connected to the passage as a floor where the user is located at the time of entering the facility. Therefore, the mobile electronic device 1b can easily identify the floor where the user is located at the time of entering the facility with high precision.

FIG. 11 is a block diagram of a mobile electronic device 1c according to still another example of the embodiments. The mobile electronic device 1c includes the display 2, the operation part 3, the communicator 4, the determinator 5, the movement detector 6, the controller 10, and the storage 20.

The determinator 5 can determine a height position of the current location in addition to latitude and longitude of the current location. The height position is a position in the height direction based on a certain height. The height position includes, for example, altitude. When the determinator 5 uses a satellite positioning system to determine a current location, the determinator 5 may determine latitude, longitude, and a height position of the current location based on signals sent from three or more satellites.

The storage 20 stores, for example, a map program 21c, map data 22c, and indoor data 23c.

The map data 22c may store information for each of floors included in the facility and information indicating the height position of each floor in association with each other. The information for each of the floors included in the facility and the information indicating the height position of the floor may be stored in the indoor data 23c. Except for the above points, the map data 22c and the indoor data 23c may be the same as the map data 22a and the indoor data 23a.

The map program 21c may be the same as the map program 21a except for a function of identifying the floor where the user is located at the time of entering the facility. According to a function provided by the map program 21c, the mobile electronic device 1c can identify the floor where the user is located at the time of entering the facility based on the height position determined by the determinator 5.

Specifically, the mobile electronic device 1c compares the height position determined by the determinator 5 and the height position associated with each of the floors included in the facility. The mobile electronic device 1c then identifies the floor associated with the height position nearest to the height position determined by the determinator 5, as a floor where the user is located at the time of entering the facility. In other words, in some embodiments, the mobile electronic device 1c may identify the floor whose height position is nearest to the determined height position as a floor where the user is located at the time of entering the facility.

Incidentally, during walking, the mobile electronic device 1c may often be held in hand, put in a pocket, or put in a bag by a user. In these cases, the mobile electronic device 1c is at a higher position than a flat surface on which the user is walking. The flat surface on which the user is walking may be referred to as, for example, ground, road, and floor.

Here, when the height position determined by the determinator 5 is compared with the height position associated with each of the floors included in the facility, the mobile electronic device 1c may correct the height position determined by the determinator 5. For example, the mobile electronic device 1c may correct the height position determined by the determinator 5 so as to be reduced by about several 10 centimeters to 1 meter. With this correction, the mobile electronic device 1c can easily identify the floor where the user is located at the time of entering the facility.

The operations of the mobile electronic device 1c will be explained in more detail below. The operations of the mobile electronic device 1c may be the same as the operations of the mobile electronic device 1a except for the floor identification processing. Therefore, the floor identification processing will be explained below.

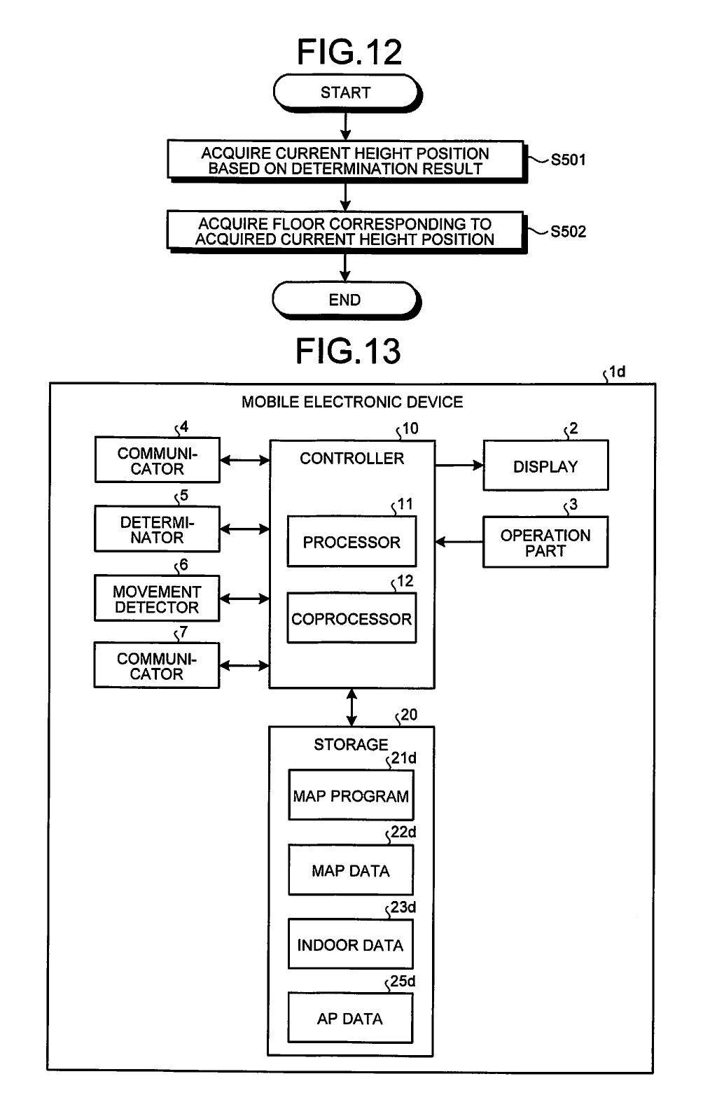

FIG. 12 is a flowchart illustrating still another example of the operations of the controller 10 in the floor identification processing. At Step S501, the controller 10 acquires a current height position from the determination result of the determinator 5 at Step S201 in the map data acquisition processing illustrated in FIG. 5. At Step S502, the controller 10 acquires the floor corresponding to the height position. More specifically, the controller 10 acquires the floor associated with the height position nearest to the acquired height position or the height position corrected. The floor acquired at Step S502 is the floor identified as the floor where the user is located at the time of entering the facility.

As explained above, the mobile electronic device 1c identifies the floor where the user is located at the time of entering the facility based on the height position determined by the determinator 5. Therefore, the mobile electronic device 1c easily identifies the floor where the user is located at the time of entering the facility with high precision.

FIG. 13 is a block diagram of a mobile electronic device 1d according to still another example of the embodiments. The mobile electronic device 1d includes the display 2, the operation part 3, the communicator 4, the determinator 5, the movement detector 6, a communicator 7, the controller 10, and the storage 20.

The communicator 7 can perform wireless data communication. The communicator 7 may support relatively short-distance wireless communications The wireless communication supported by the communicator 7 may include, for example, WiFi. The communicator 7 may perform communication with other communication device via a wireless base station which is apart from the communicator 7 by, for example, about several meters to 10 meters. Hereinafter, to distinguish between this base station and the base station for performing wireless communication with the communicator 4, the base station for performing wireless communication with the communicator 7 may be referred to as AP (access point).

The communicator 7 may include a function of detecting a neighboring AP and a function of performing communication with a communication device through wireless communication with the detected AP. The neighboring AP may be detected by scanning a predetermined frequency band. By scanning the predetermined frequency band, the communicator 7 may acquire ID included in a radio signal sent out by the neighboring AP, intensity of the radio wave received from the AP, and the like.

The storage 20 stores, for example, a map program 21d, map data 22d, indoor data 23d, and AP data 25d.

The AP data 25d includes information for a known AP. The information for AP includes, for example, ID of AP.

The map data 22d and the indoor data 23d are associated with the AP data 25d and are stored in the storage 20. For example, the AP data 25d may store information indicating an element, a floor, and a facility in which the AP is located. Alternatively, the AP data 25d may store information indicating latitude, longitude, and a height position of each AP located, and at least one of the map data 22d and the indoor data 23d may store information for a height position of each of the floors included in the facility. In this way, the mobile electronic device 1d may be set so that it can determine an element, a floor, and a facility in which the AP, corresponding to the information stored in the AP data 25d, is located.

Except for the above points, the map data 22d and the indoor data 23d may be the same as the map data 22a and the indoor data 23a.

The map program 21d may be the same as the map program 21a except for a function of identifying the floor where the user is located at the time of entering the facility. According to a function provided by the map program 21d, the mobile electronic device 1d can identify the floor where the user is located at the time of entering the facility based on the result of the AP detected by the communicator 7.

Specifically, the mobile electronic device 1d identifies the floor where the user is located at the time of entering the facility based on a combination of the detected APs, the intensity of the radio wave received from each of the detected APs, and the like.

For example, it is assumed that AP-1X, AP-3Y, and AP-5Z are installed at a store X on the first floor, at a store Y on the third floor, and at a store Z on the fifth floor of a facility, respectively, and that these APs are detected by the communicator 7. In this case, the mobile electronic device 1d may calculate a prediction range of the current location of the mobile electronic device 1d based on a three-dimensional position of the store X and the intensity of the radio wave received from the AP-1X. The calculated prediction range is, for example, a sphere centered at a position of the store X. Likewise, the mobile electronic device 1d may calculate a prediction range of the current location of the mobile electronic device 1d based on a three-dimensional position of the store Y and the intensity of the radio wave received from the AP-3Y. Moreover, the mobile electronic device 1d may calculate a prediction range of the current location of the mobile electronic device 1d based on a three-dimensional position of the store Z and the intensity of the radio wave received from the AP-5Z.

The mobile electronic device 1d may determine the position where the three prediction ranges calculated in the above manner overlap, as a location of the mobile electronic device 1d. The location of the determined mobile electronic device 1d is a relative and three-dimensional position based on the three-dimensional positions of the store X, the store Y, and the store Z. The mobile electronic device 1d may determine the floor of the facility including the store X, the store Y, and the store Z to which the height position of the mobile electronic device 1d corresponds, based on the location of the mobile electronic device 1d determined in the above manner and the floors where the store X, the store Y, and the store Z are located.

The mobile electronic device 1d may identify the floor where the user is located at the time of entering the facility based on an average of the floors where detected APs are located or based on an averaged floor obtained by weighting the floors where the detected APs are located according to the intensities of radio waves received from the APs. By doing this, the mobile electronic device 1d can more easily perform the floor identification processing.

Even when the location of AP is defined by three-dimensional coordinate values of the latitude, longitude, and height position etc., the mobile electronic device 1d may identify the floor where the user is located at the time of entering the facility, similarly to the above example. For example, the mobile electronic device 1d may determine the position, where the prediction ranges calculated from the coordinate values of the locations of the detected APs and the intensities of the radio waves overlap, as a location of the mobile electronic device 1d. Then, by comparing the height position of the determined location with the height position of each of the floors in the facility, the mobile electronic device 1d may identify the floor where the user is located at the time of entering the facility. As for the method of identifying the floor where the user is located at the time of entering the facility based on the height position, the already explained method may be used.

The operations of the mobile electronic device 1d will be explained in more detail below. The operations of the mobile electronic device 1d may be the same as those of the mobile electronic device 1a except for a floor identification processing. Therefore, the floor identification processing will be explained below.

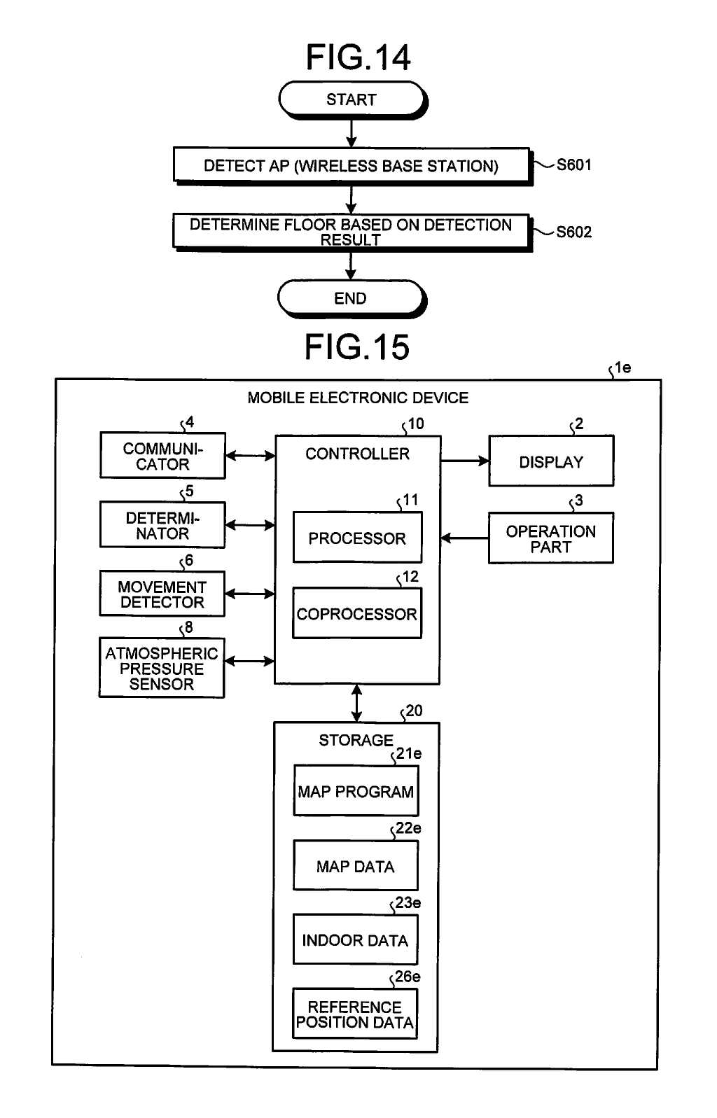

FIG. 14 is a flowchart illustrating still another example of the operations of the controller 10 in the floor identification processing. At Step S601, the communicator 7 detects an AP. At Step S602, the controller 10 identifies the floor where the user is located at the time of entering the facility based on the detection result of the AP.

As explained above, the mobile electronic device 1d identifies the floor where the user is located at the time of entering the facility based on the result of the AP detected by the mobile electronic device 1d. Therefore, the mobile electronic device 1d can identify the floor where the user is located at the time of entering the facility with high precision.

FIG. 15 is a block diagram of a mobile electronic device 1e according to still another example of the embodiments. The mobile electronic device 1e includes the display 2, the operation part 3, the communicator 4, the determinator 5, the movement detector 6, an atmospheric pressure sensor 8, the controller 10, and the storage 20.

The atmospheric pressure sensor 8 measures ambient or internal pressure of the mobile electronic device 1e. The atmospheric pressure sensor 8 has a detection precision such that, for example, a change in atmospheric pressure in association with a change in the height position of the mobile electronic device 1e by about several 10 centimeters to 1 meter can be detected.

The storage 20 stores, for example, a map program 21e, map data 22e, indoor data 23e, and reference position data 26e.

A height position and an atmospheric pressure of a point through which the mobile electronic device 1e passes during movement are recorded in the reference position data 26e. In the following, the point recorded in the reference position data 26e may be referred to as a reference position. The height position is acquired by using, for example, the determinator 5. The latitude and the longitude of the reference position may further be recorded in the reference position data 26e.

A reference position is recorded in the reference position data 26e each time a predetermined time passes during the movement or each time a moving distance reaches a predetermined length. Alternatively, the defined height positions are previously recorded in the map data 22e, and the reference position may be recorded each time the mobile electronic device 1e passes through the point whose height position is previously recorded in the map data 22e. In this case, the determinator 5 does not need to determine the height position of the reference position in order to acquire it. The mobile electronic device 1e may record the reference position using the coprocessor 12 in order to reduce the power consumption.

The map data 22e may store the information for each of the floors included in the facility and the information indicating a height position of each floor in association with each other. The information for each of the floors included in the facility and the information indicating a height position of each floor may be stored in the indoor data 23a. Except for the above points, the map data 22e and the indoor data 23e may be the same as the map data 22a and the indoor data 23a.

The map program 21e may be the same as the map program 21a except for a function of identifying the floor where the user is located at the time of entering the facility. According to a function provided by the map program 21e, the mobile electronic device 1e can identify the floor where the user is located at the time of entering the facility based on the fluctuation of the atmospheric pressure detected by the atmospheric pressure sensor 8.

Specifically, the mobile electronic device 1e acquires a pressure difference between the atmospheric pressure at the current location measured by the atmospheric pressure sensor 8 and the atmospheric pressure measured at the reference position recorded in the last reference position data 26e. The mobile electronic device 1e may calculate a height position of the current location from an altitude difference calculated from the acquired pressure difference and the height position of the last reference position. Thereafter, by applying the above-described method to the floor identification processing, the mobile electronic device 1e may identify the floor where the user is located at the time of entering the facility from the calculated height position of the current location.

The operations of the mobile electronic device 1e will be explained in more detail below. The operations of the mobile electronic device 1e may be the same as those of the mobile electronic device 1a except for a floor identification processing. Therefore, the floor identification processing will be explained below.

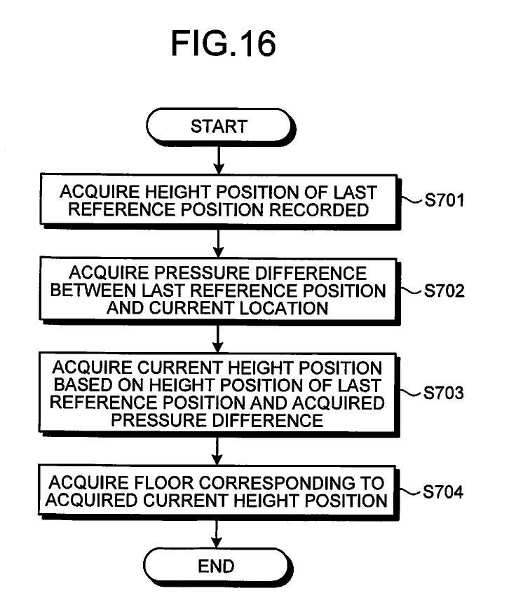

FIG. 16 is a flowchart illustrating still another example of the operations of the controller 10 in the floor identification processing. At Step S701, the controller 10 acquires the height position of the last reference position recorded in the reference position data 26e. At Step S702, the controller 10 calculates a difference between the acquired atmospheric pressure at the reference position and the atmospheric pressure at the current location measured by the atmospheric pressure sensor 8 to acquire a pressure difference between the reference position and the current location.

At Step S703, the controller 10 calculates a height position of the current location from the height position at the reference position and from the pressure difference. At Step S704, the controller 10 acquires the floor corresponding to the height position. The floor acquired at Step S704 is the floor identified as the floor where the user is located at the time of entering the facility.

As explained above, the mobile electronic device 1e may identify the floor where the user is located at the time of entering the facility based on the fluctuation of the atmospheric pressure detected by the atmospheric pressure sensor 8. Therefore, the mobile electronic device 1e can identify the floor where the user is located at the time of entering the facility with high precision.

The embodiments disclosed in the present disclosure can be modified within a scope that does not depart from the gist and the scope of the disclosure. Moreover, the embodiments and modifications thereof disclosed in the present disclosure can be combined with each other if necessary.

For example, the programs such as the map programs 21a to 21e may be divided into a plurality of modules, or may be combined with other programs.

When the embodiments and the modifications are to be combined, the accuracy of the identified floor may be evaluated in each identification method based on the used parameters, the result of calculation using the parameters, and the accuracy of the method itself, and the floor identified by using the method the accuracy of which is evaluated as the highest may be adopted.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A mobile electronic device comprising:
a display configured to display a map; and
at least one controller configured to control display within an area indicating a facility in the map according to a distance between the mobile electronic device and the facility.

2. The mobile electronic device according to claim 1, wherein the at least one controller is configured to control the display within the area indicating the facility according to a detected moving means and the distance.

3. The mobile electronic device according to claim 1, wherein
the at least one controller is configured to identify a floor of the facility according to a current location when the distance between the mobile electronic device and the facility is shorter than a predetermined distance, and to display information corresponding to the identified floor within the area indicating the facility.

4. The mobile electronic device according to claim 1, further comprising:
a determinator configured to determine a height position of the mobile electronic device, wherein
the at least one controller is configured to identify a floor of the facility according to the height position of the mobile electronic device determined by the determinator, and to display information corresponding to the identified floor within the area indicating the facility.

5. The mobile electronic device according to claim 1, further comprising:
a communicator configured to detect a neighboring wireless base station, wherein
the at least one controller is configured to identify a floor of the facility according to the wireless base station detected by the communicator, and to display information corresponding to the identified floor within the area indicating the facility.

6. The mobile electronic device according to claim 1, wherein
the at least one controller is configured to identify a floor of the facility according to a movement path of the mobile electronic device, and to display information corresponding to the identified floor within the area indicating the facility.

7. The mobile electronic device according to claim 1, further comprising:
an atmospheric pressure sensor configured to detect an atmospheric pressure, wherein
the at least one controller is configured to identify a floor of the facility according to a change in the atmospheric pressure detected by the atmospheric pressure sensor, and to display information corresponding to the identified floor within the area indicating the facility.

8. A control method for controlling a mobile electronic device, comprising:
displaying a map on a display; and
controlling display within an area indicating a facility in the map according to a distance between the mobile electronic device and the facility.

9. A non-transitory storage medium configured to store a control program for causing a mobile electronic device to execute:
displaying a map on a display; and
controlling display within an area indicating a facility in the map according to a distance between the mobile electronic device and the facility.
